(19) United States
(12) Patent Application Publication
(10) Pub. No.: US 2009/0180515 A1
(43) Pub. Date: Jul. 16, 2009

(54) Sensor system and method for operating a sensor system

(75) Inventors: Armin Kiefer, Freiburg (DE); Leonard Reindl, Freiberg (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/150,737

(22) Filed: Apr. 30, 2008

(30) Foreign Application Priority Data
Jan. 10, 2008 (DE) 10 2008 003 793.1

(51) Int. Cl. G01K 7/00; G01K 7/16

(52) U.S. Cl. 374/185; 374/163; 374/E07.018

(57) ABSTRACT

A sensor system includes a low temperature portion adapted for use in a low temperature environment; a high temperature portion adapted for use in a high temperature environment; a sensor arranged within the high temperature portion; and a measurement unit functionally connected to the sensor to read out respective sensor signals. The measurement electronics is arranged within the high temperature portion

### BACKGROUND OF THE INVENTION

### Field of the Invention

The present invention relates in general to sensor systems and methods for operating a sensor system, in particular to sensor/actuator systems.

Power actuators are often operating at high temperatures and in aggressive environments. Additional sensors for monitoring and control usually require complex cabling and connectors that are prone to errors. In a classical arrangement for a metering point at a power actuator, only the sensor element itself is placed close to the actuator in the high temperature zone and the delicate electronic circuits, for signal conditioning and data interfacing, are located separately in a zone with lower temperature. Another fundamental disadvantage of this readout method is the transmission of the weak sensor signals over long interference-prone analog signal wires.

Recent approaches aimed at reducing the cabling efforts for sensor data transmission include Power Line Communication and wireless radio technologies.

Prior art Power Line Communication utilizes public power lines to transfer data, as, e.g., disclosed in N. Pavlidou, A. J. Han Vinck, J. Yazdani, B. Honary, “Power line communications-State of the art and future trends”, IEEE Communications Magazine, Vol. 41, no. 4, pp. 34-40, April 2003. Communication problems are common because of numerous participants with varying impedance characteristics, a range of electro-magnetic interferences, and the unknown topology of the public power line. Unpredictable frequency-dependent, location-dependent and time-variant minima of signal strength cannot be avoided, as disclosed, e.g., in M. Zimmermann, K. Dostert, “a multipath model for the powerline channel”, IEEE Transactions on Communications, Vol. 50, no. 4, pp. 553-559, April 2002. Therefore, at some locations in the net it is impossible to communicate at all, which is unacceptable for industrial applications. Recent sophisticated concepts for power line modems, e.g., using multiple carrier frequencies, try to overcome these difficulties but require higher priced hardware.

Another emerging way to minimize cabling efforts for industrial sensors is using wireless radio techniques, as disclosed, e.g., in A. Willig, M. Kubisch, C. Hoene, A. Wolisz, “Measurements of a wireless link in an industrial environment using an IEEE 802.11-compliant physical layer”, IEEE Transactions on Industrial Electronics, Vol. 49, no. 6, pp. 1265-1282, December 2002; or L. Reindl, I. Shrena, H. Richter, R. Peter, “High precision wireless measurement of temperature by using surface acoustic waves sensors”, Proc. 2003 IEEE Freq. Control Symp.

But low-cost transceivers that are currently available on the market have a maximum operating temperature of only 85° C. Therefore, they are not qualified for high temperature applications above 85° C., in particular at 125° C. or higher. Furthermore, the transmission reliability of a wireless radio connection is not guaranteed for critical implementations.

There is a need for a reliable measurement of sensor data in a high temperature environment.

### BRIEF SUMMARY OF THE INVENTION

Under one aspect of the invention, a sensor system comprises a low temperature portion adapted for use in a low temperature environment (zone); a high temperature portion adapted for use in a high temperature environment; a sensor arranged within the high temperature portion; and a measurement unit functionally connected to the sensor to read out respective sensor signals. The measurement electronics is arranged within the high temperature portion. This reduces the length of the sensor wires and improves reliability of the measurement.

In general, a reference to “a” or “the” certain entity may also include a plurality of these entities if not indicated otherwise. Thus, the sensor system may comprise one or more sensors arranged within the high temperature portion, for example.

Advantageously, the measurement electronics are arranged in close vicinity of or directly at the sensor. This eliminates the need for long and error-prone sensor wires and greatly improves reliability of the measurement.

Advantageously, the sensor system further comprises an electrical load element arranged within the high temperature portion.

Advantageously, the measurement electronics are arranged in close vicinity of or directly at the electrical load element. This may give a compact design and a reliable measuring environment.

Advantageously, the electrical load element comprises an actuator.

Advantageously, the actuator comprises a power actuator.

Alternatively or additionally, the electrical load element comprises a resistive heating element. This is particularly advantageous for use with a household appliance like a cooking system, e.g., for use with a cookware, a coffee maker, etc.

Advantageously, the electrical load element is electrically fed via a power line and the power line is also connected to the measurement unit for data communication.

Advantageously, the power line is functionally connecting the measurement electronics and a control unit for data communication wherein the control unit is arranged within the low temperature portion.

Advantageously, the control unit is adapted to receive sensor data via the measurement electronics and to control a power supply to the electric load element.

Advantageously, the data communication comprises a Power Line Communication. This Power Line Communication technique may be implemented with low-cost and temperature resistant elements.

Advantageously, a carrier frequency for the Power Line Communication data communication is in the range of MHz.

Advantageously, the carrier frequency equals a clock frequency of a logic circuitry.

Advantageously, the Power Line Communication is adapted to employ an Amplitude Shift Keying, modulation. Alternatively, other modulation methods may be used like Frequency Shift Keying, and Phase Shift Keying in their respective variations.

For easy and robust operation, Amplitude Shift Keying modulation advantageously comprises an On/Off Keying modulation.

Advantageously, a maximum peak-to-peak Amplitude Shift Keying amplitude ranges from 1 Volt to 5 Volts.

Advantageously, a frequency of a power current is in the range of KHz.

Advantageously, the measurement unit comprises a data transmitter.

Advantageously, the measurement unit comprises a data transmitter including a modulator for modulating outgoing data.

Advantageously, the modulator comprises a single logic NAND gate.

Advantageously, for bi-directional data communication, the measurement unit further comprises a data receiver including a demodulator for demodulating incoming data.

Advantageously, to reduce unwanted signal portions, the sensor system further comprises a band pass filter connected in series with at least one of the modulator and demodulator.

Advantageously, the transmitter and the receiver are part of a transceiver unit.

Advantageously, the transceiver unit is adapted to operate in a half duplex mode.

Advantageously, the transceiver unit is integrated on a single chip, e.g., within an ASIC.

Advantageously, the transceiver unit is functionally connected to a logic circuitry, e.g. microcontroller or microprocessor, connecting the transceiver circuit to the sensor.

Advantageously, the measurement unit comprises an analog interface for connection with the sensor.

Advantageously, the analog interface comprises a multiplexer with an input port and several output ports for consecutively switching a measuring current from the input port to the several output ports; and wherein at least one of the output ports of the analog interface is connected to a resistive sensor element.

Advantageously, several of the output ports of the analog interface are each connected to a respective resistive sensor element.

Advantageously, the resistive sensor element comprises a Resistance Temperature Detector.

Advantageously, two of the output ports of the analog interface each being connected to a respective reference resistor.

Advantageously, the sensor system being adapted to measure a sensor value employing a ratiometric measurement technique.

Advantageously, the multiplexer being swept between five and twenty times a second.

Advantageously, the analog interface is coupled to a logic circuitry of the transceiver circuit via an analog-to-digital converter.

Advantageously, the measurement electronics is integrated on a single chip, e.g., an ASIC.

Advantageously, the sensor system further comprises a data transmission means connecting the measurement electronics and a control unit arranged within the low temperature portion.

Advantageously, the sensor system further comprises a contactless connector with inductive coupling, wherein a low temperature side of the contactless connector is connected to the control unit via a first section of the power line and wherein a high temperature side of the contactless connector is connected to the electrical load element and the measurement electronics via a second section of the power line.

Advantageously, the low temperature side of the contactless connector is part of a household appliance.

Advantageously, the high temperature side of the contactless connector is part of a cookware.

Advantageously, the high temperature side of the contactless connector is part of a coffee maker, e.g., an espresso machine, in particular if the electrical load element is an electrical heating element.

Under another aspect of the invention, a household appliance system includes a sensor system, wherein the sensor system comprises a low temperature portion adapted for use in a low temperature environment; a high temperature portion adapted for use in a high temperature environment; a sensor arranged within the high temperature portion; a measurement unit functionally connected to the sensor to read out respective sensor signals, wherein the measurement electronics is arranged within the high temperature portion.

Advantageously, the household appliance further comprises an electrical load element arranged within the high temperature portion, wherein the electrical load element is electrically fed via a power line and wherein the power line is also connected to the measurement unit for data communication.

Advantageously, the power line is connecting the measurement electronics and a control unit for data communication, wherein the control unit is arranged within the low temperature portion, and wherein the control unit is adapted to receive sensor data from the measurement electronics and to control a power supply to the electric load element.

Under another aspect of the invention, a household appliance comprises an electrical load element, a sensor and a measurement unit functionally connected to said sensor to read out respective sensor signals; wherein said electrical load element, said sensor and said measurement electronics are adapted for use within a high temperature environment; and wherein said electrical load element is electrically fed via a power line and wherein said power line is also connected to said measurement unit for data communication; and further comprising one side of a contactless connector with inductive coupling, that is connected to said electrical load element and said measurement electronics via said power line. The above mentioned advantageous embodiments are also applicable for this aspect of the invention.

Under even another aspect of the invention, a method for operating a sensor system comprises: a low temperature portion adapted for use in a low temperature environment; a high temperature portion adapted for use in a high temperature environment; a sensor arranged within the high temperature portion; a measurement unit functionally connected to the sensor to read out respective sensor signals, wherein the measurement electronics is arranged within the high temperature portion; the method comprises the step of measuring, by the measurement unit, a sensor value using a ratiometric measuring technique. The above mentioned advantageous embodiments are also applicable for this aspect of the invention.

Under yet another aspect of the invention, a method for sensing a sensor value the steps of: measuring a sensor signal from a sensor arranged in a high temperature environment; transforming, by a measurement electronics arranged in the high temperature environment, the sensor signal into a sensor value; and transmitting the sensor value to a control unit arranged in a low temperature environment by means of a Power Line Communication technique. The above mentioned advantageous embodiments are also applicable for this aspect of the invention.

The following detailed description and the accompanying drawings provide a better understanding of the nature and advantages of the FIFO circuitry according to the present invention.

### BRIEF DESCRIPTION OF THE DRAWINGS

In the following, one exemplary embodiment of a sensor/actuator system is schematically described.

FIG. 1 shows a block diagram of a known arrangement for a sensor system arrangement comprising a metering point at a power actuator.

FIG. 2 shows an exemplary block diagram of a sensor system according to the invention.

FIG. 3 shows an exemplary block diagram of measurement electronics of the sensor system of FIG. 2.

FIG. 4 shows an exemplary block diagram of an analog interface portion of the measurement electronics of FIG. 3.

FIG. 5 shows a more detailed block diagram of a transceiver portion of the measurement electronics of FIG. 3.

FIG. 6 shows a picture of a hardware embodiment of a sensor system.

FIG. 7 shows experimental measurement results in terms of a measurement error with respect to an ambient temperature.

### DETAILED DESCRIPTION OF THE INVENTION

An exemplary embodiment of the present invention is now described with reference to the figures, where like reference numbers indicate identical or functionally similar elements. Also in the figures, the left most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of devices, systems, and applications.

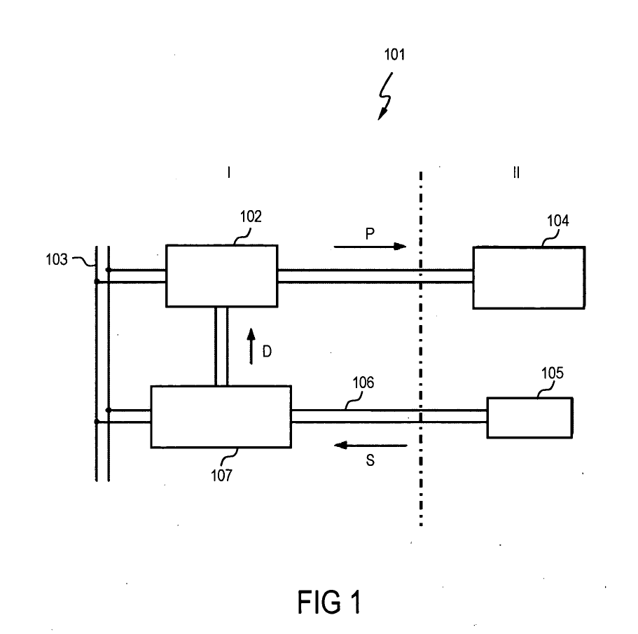

FIG. 1 shows a prior art sensor/actuator arrangement 101 having a control unit 102 that is connected to a power line 103. Control unit 102 is adapted to control feeding electrical power P to an actuator 104. While control unit 102 is arranged in a low temperature environment I of up to 85° C., actuator 104 is arranged in a high temperature environment II of about 125° C. In high temperature environment II is also arranged a temperature sensor element 105 which is connected over long and error-prone analog signal wires 106 to a measurement electronics 107 which in turn is placed in the low sensor/actuator arrangement 101 (low temperature zone) I. Sensor 205 is sending sensor signals S to the measurement unit 207 (or, in analogy, measurement unit 207 is reading out sensor signals S from sensor 205). Measurement unit 207 sends sensor values D corresponding to the sensor signals S to the control unit 102. Control unit 102 uses the sensor values D to control power P. This corresponds to a closed-loop control for controlling the Power P on the basis of the sensor 205 readings.

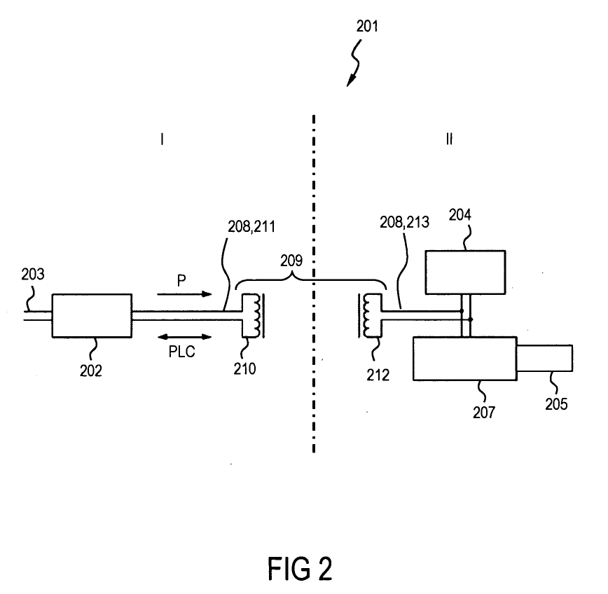

FIG. 2 shows a sensor/actuator arrangement 201 wherein a control unit 202 is connected to a power line 203. Control unit 202 is arranged within a low temperature environment I and controls the feeding of electrical power P to an actuator 204 arranged in the high temperature environment II. Within a high temperature environment II are also arranged a sensor element 205 and a measurement electronics 207.

The electrical power P is fed to the actuator 204 via a power line 208. The power line 208 comprises a separable transformer representing a contactless connector 209 with inductive coupling, wherein a low temperature 210 side of the contactless connector 209 is connected to the control unit 202 via a first section 211 of said power line 208 and wherein a high temperature side 212 of said contactless connector 209 is connected to said actuator 204 via a second section 213 of the power line 208.

The measurement electronics 207 are placed near to or directly at the actuator 204 within the high temperature zone II and is also connected to the second section 213 of the power line 208. By using this power line connection, measurement electronics 207 is able to use the existing power line 208 between the actuator 204 and its associated control unit 202 to establish a point-to-point power line communication (PLC) with the control unit 202. Accordingly, the contactless connector 209 is adapted to transmit both AC power and bidirectional Power Line Communication (PLC). Because of the point-to-point communication, influences from other participants and from complex power line topologies are excluded, thus a low cost PLC transceiver with a simple modulation technique and a sparse input filtering is sufficient.

Measurement electronics 207 are further connected to the sensor element 205. Thus, the measurement electronics 207 can be located as close as possible to the sensor element 205, as shown, and no long and interference-prone analog signal wires are needed. Through the ongoing proceedings in the automotive field, almost all standard electronic components, like microprocessors, operational amplifiers, or logic ICs are now available with automotive temperature specifications ranging up to 125° C. operating temperature at low prices.

As described above, another advantage of using Power Line Communication is that its respective data signals can be transmitted via inductive coupling. In the present case, the inductive coupling is achieved between two coils 210, 212 or between primary winding 210 and secondary winding 212 of a contactless connector implemented as a transformer 209. In the shown embodiment, a variable driving voltage of 10 to 230 V AC with a frequency of 100 kHz for the actuator 204 is used that can easily be transferred over the transformer 209. Designing the transformer 209 such that it can be separated in the middle leads to the contactless connector with inductive coupling. Both electrical power and data are transferred simultaneously over the lines 211, 213 and over the magnetic field of the transformer 209 but are operating at different frequencies.

Especially in chemical process and household engineering such connectors 209 without any electrical or direct mechanical contact might be preferred because of their robustness and long lifetime. They are resistant to both abrasion and corrosion, allowing for a perfect hermetic seal. The surface may be absolutely flat so that no dirt can accumulate. Furthermore, applications in aggressive environments and in explosive atmosphere are possible.

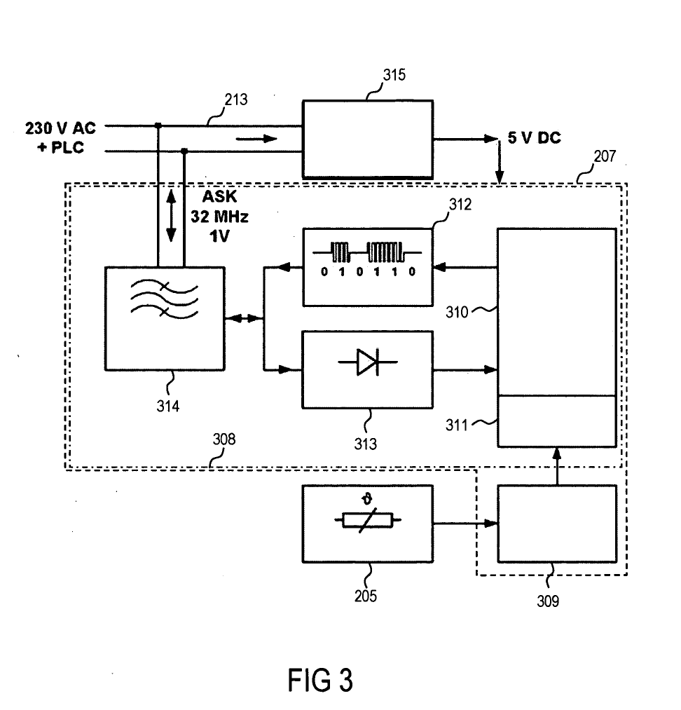

FIG. 3 shows the measurement electronics 207 of the sensor system of FIG. 2 in greater detail.

Measurement electronics 207 comprise a discrete low-cost transceiver circuit 308 operable up to 125° C. for PLC data transmission via the power line 213 and an analog interface 209 for interfacing the sensor element(s) 205. The transceiver circuit 308 comprises a microprocessor 310 that generates a PLC data stream to be transmitted to the control unit via the power line 213. This data stream is generated based on sensor values (sensor data) received from the analog interface 309. The analog interface 309, in turn, receives the raw sensor signals corresponding to the state of the sensor element(s) 205, processes them into readable analog (relative or absolute) values, and transmits the sensor values to the microprocessor 310 via an analog-to-digital converter 311. Transmission of the outgoing data stream (with respect to the transceiver circuit 308) comprising sensor data is achieved via a modulator 312 that modulates the data stream onto the power signal of the power line 208, using a respective carrier wave. For processing data received over the power line 208 (incoming data with respect to the transceiver circuit 308), a demodulator 313 is used to generate a data stream suitable for input into the microprocessor 310 based on the incoming data. The transceiver circuit 308 employs only very few and inexpensive parts.

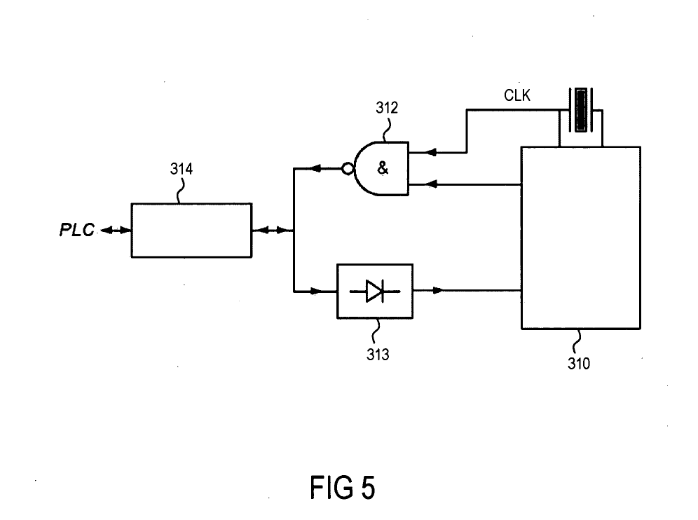

The transceiver circuit 308 is now described in greater detail in combination with FIG. 5. A clock frequency of a clock of the microprocessor 310 of several megahertz is used as carrier frequency for the PLC, thus no extra oscillator is needed. The simplest and most common Amplitude Shift Keying modulation technique, the on-off-keying, is sufficient. The modulator 312 itself is build out of a single logic NAND gate, which outputs the carrier frequency in accordance with the digital data bit stream and with an amplitude of approximately 5 V peak-to-peak.

By using Amplitude Shift Keying that works with a single carrier frequency, the complexity of a filtering is reduced. For the same reason only a half duplex communication is implemented, utilizing one physical channel and one carrier frequency but one direction (outgoing/incoming; outbound/inbound). For filtering the PLC signal, a band pass filter 314 is used. The band pass filter 314 mainly has two functions: a major task is to provide a high pass filter for the communication carrier frequency that suppresses all lower frequencies coming from the power line 213. In particular, it has to suppress the huge amplitude of up to 230 V AC (325 V peak) of the power line voltage. In the shown embodiment, up to 230 V AC may be used for the power signal with a frequency of 100 kHz generated by a switching power supply 315. Thus, the filter 314 has to eliminate the associated conducted electro-magnetic interference spectrum as well. A further task of the band pass filter 315 is to form a sine shape carrier frequency out of the digital square shape signal coming out of the logic NAND gate modulator 312 by suppressing the higher harmonics.

Due to the point-to-point communication, which is not open to the outside world, all influences on the communication channel are calculable. For this reason an Amplitude Shift Keying amplitude of 1 to 5 V peak-to-peak is expected to be sufficient under all operation conditions. For demodulating such high signal amplitudes no costly RF amplifier is necessary in the receiver circuitry. Rather, a simple envelope detector with a fast silicon diode as detector element (not shown) is sufficient for the demodulator 313. By biasing the forward voltage of this diode and compensating the temperature drift with a second diode (not shown) of the demodulator 313, signal amplitudes down to 0.1 V can be detected reliably. A following comparator (not shown) of the demodulator 313 generates a CMOS logic voltage level signal for feeding into the microprocessor 310.

To achieve the highest possible operating temperature, a self-heating of the measurement electronics 207 due to its own power dissipation should be minimized. Therefore, only electronic devices with low power consumption are selected. Also, the clock frequency of the microprocessor 310 is reduced as low as possible by using internal frequency dividers. In addition, the microprocessor 310 enters a sleep mode or different sleep modes, respectively, whenever no activity is needed.

The required power for the measurement electronics 207 has to be generated out of the driving voltage for the actuator 204. Often this driving voltage is not only switched on and off but is modulated in amplitude or pulse width. AC drive voltage can also be modulated by phase control. Therefore, a universal switching power supply 315 is used that can operate from 5 V DC up to 230 V AC with a frequency of up to several hundred kilohertz even with a modulated driving voltage. To minimize self-heating, a switching mode voltage regulator with high efficiency and a coil with low losses are used.

Another advantage of designing the measurement electronics 207, including the PLC transceiver 308, out of discrete standard components is that such a circuit can be easily integrated into an Application Specific Integrated Circuit. In addition, the microprocessor 310 may then be replaced by a less complex state machine within the Application Specific Integrated Circuit. Thereby the costs and overall size of the measuring electronics 207 will be minimized in a next design step.

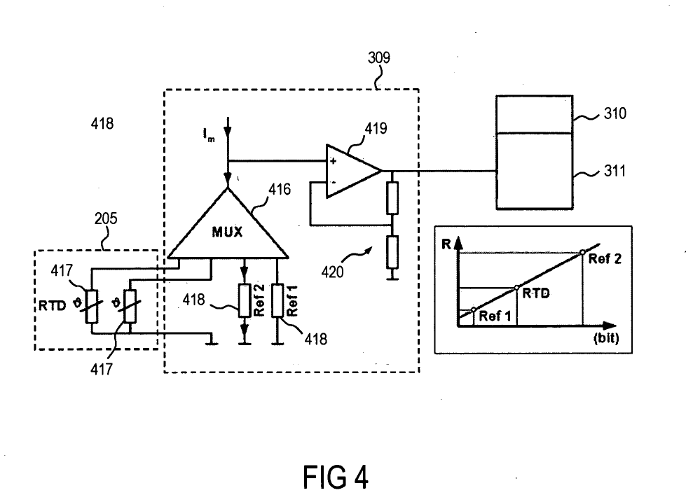

FIG. 4 shows the analog interface portion 309 of the measurement electronics 207 and the sensor element 205 of FIG. 3 in greater detail.

The analog interface portion 309 is adapted to perform a repetitive self-calibration that eliminates temperature drifts. The analog interface portion 309 comprises a multiplexer 416 that receives a measuring current Im at its input port and that is adapted to switch the measuring current Im to a respective of several output ports. In the present embodiment, the sensor element 205 comprises two Resistance Temperature Detectors (RTD) 417 that are on one side connected to a respective output port of the multiplexer 416 and to ground (or any lower voltage potential) on the other side. The RTDs 417 are measured 10 times per second by correspondingly switching the measuring current Im over the multiplexer 416 (sweeping the multiplexer 416 at a rate of 10 sweeps/s). In other words, the multiplexer 416 is directing the measuring current Im through each RTD 417 ten times a second. The strength of the current Im depends on the resistance value of the respective RTD 417 which in turn depends on the temperature at the RTD 417. The measuring current Im is input into a non-inverting input port of an operational amplifier 419 whereas its inverting input port is connected to a voltage divider 420 connected between the output of the operational amplifier 419 and ground. The value of current Im is thus translated into a corresponding scaled voltage value that is input into the analog-to-digital converter 311 to be fed into the microprocessor for further processing/calculation.

To ensure stability over a wide temperature range, a special self-calibration technique with two additional reference resistors 418 is implemented. The reference resistors 418 are also connected between a respective output port of the multiplexer 416 and ground, and the respective measuring current Im flowing through them is also sampled.

In the present case, only two precision components 418 are thus required for the whole circuitry 309. These reference resistors 418 have a ±0.1% tolerance and a temperature coefficient of less than ±10 ppm/K. For all other passive components and semiconductors, non-precision devices are sufficient. Due to repetitive self-calibration, prior to every measurement cycle, all tolerances, temperature drifts, offset errors, gain errors and aging are completely eliminated. The only necessary requirements are linearity of the entire measuring chain and low leakage currents in the multiplexer 416. The analog signal conditioning which consists mainly of operational amplifiers and resistors usually features an excellent linearity. Only the following analog to digital converter 311 typically has a slight significant linearity error.

The actual measurement is performed by a ratiometric measuring technique. Through a simple linear interpolation between the two conversion results of the known reference resistor 418 values and the conversion result of the unknown RTD 417, the unknown resistance of the RTD 417 is calculated by the microprocessor 310, as shown in the right-hand side diagram. There, the quantized voltage value from the amplifier 419 output corresponding to the measuring current Im is matched to a corresponding resistance value by matching the quantized voltage value on the x-axis with a resistor value lying on the line between the (known) points for the reference resistors 418. This gives a highly accurate resistance value of the RTD 417 and thus a highly accurate temperature value. This can be extended to two or more RTDs 417, as implemented in FIG. 4.

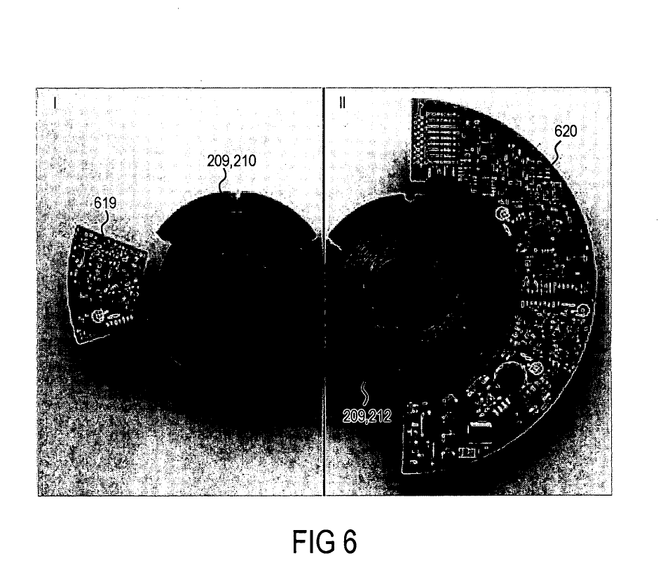

FIG. 6 shows a picture of a hardware implementation wherein nine RTD inputs are implemented on a Printed Circuit Board with discrete components and a standard single-chip microprocessor. The left Printed Circuit Board 619 is adapted for use within the low temperature zone I and is equipped with a PLC transceiver for the control unit. The right Printed Circuit Board 620 is adapted for use within the high temperature zone II and is equipped with high temperature resistant measurement electronics, PLC transceiver, and switching power supply. Between Printed Circuit Boards 619, 620 is shown the separable transformer 209 with primary winding 210 and secondary winding 212.

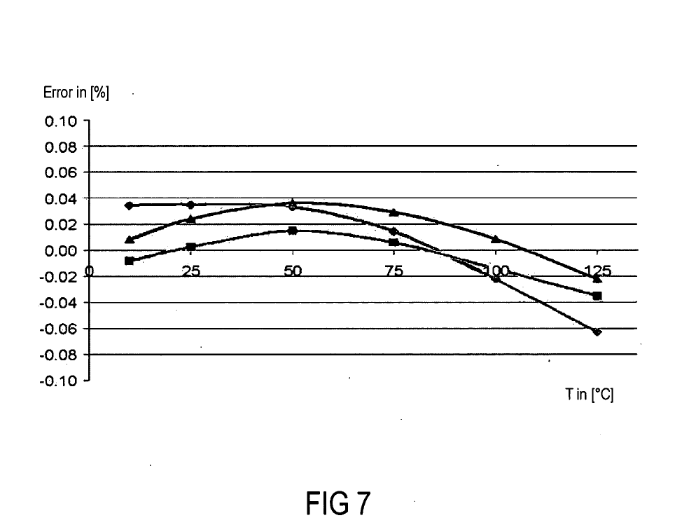

FIG. 7 shows a diagram plotting a measurement error in percent of the measuring electronics over an operating temperature range from 0 to 125° C. A measuring accuracy of better than 0.1° C. could be reached wherein at each RTD input an external precision resistor with a fixed value was connected and was kept at constant temperature. Also, the stability of the measuring circuitry in continuous operation at 125° C. and during temperature cycling was verified.

Generally, data transmission reliability of the point-to-point PLC was tested successfully even under worst conditions, as lowest ASK signal level, highest electro-magnetic interferences of the actuator power supply, an air gap of up to 10 mm at the inductive coupling path, and an operating temperature of 125° C. Thus, the system is outstandingly qualified even for critical closed-loop control applications that require continuous unfailing measurement data flow

The complete electronics 207 for signal conditioning, self-calibration, and bidirectional Power Line Communication may be integrated directly into a housing of the actuator 204 to achieve a compact sensor/actuator system 201. Through a cost-effective hardware design and the benefits of synergy effects between different circuit parts, a low-cost solution for the instrumentation hardware is found that is also suitable for integration into an ASIC. The separable transformer 209 serves as an inductively coupled short-range wireless link for AC power and modulated bidirectional data without any mechanical or electrical contact, allowing for a perfect hermetic seal even in aggressive environments.

As the costs per metering point are very low, many applications at high temperatures (>85° C.) and in aggressive environments are feasible with this measurement technique, e.g. in a household appliance.

While one exemplary embodiment of the present invention has been described above, it should be understood that they have been presented by way of example, and not limitation. After reading and understanding the present detailed description, many modifications, variations, alternatives, and equivalents will be apparent to a person skilled in the art and are intended to be within the spirit and scope of this invention. Therefore, the specific embodiment described is not intended to be exhaustive or to limit the invention, and the invention is intended to be accorded the widest scope consistent with the principles and novel features disclosed herein, and as defined by the following claims.

1. A sensor system, comprising:
a low temperature portion adapted for use in a low temperature environment;
a high temperature portion adapted for use in a high temperature environment;
a sensor within said high temperature portion; and
a measurement unit in said high temperature portion and functionally connected to said sensor to read out respective sensor signals.

2. The sensor system of claim 1, wherein said measurement unit is arranged in close vicinity of or directly at said sensor.

3. The sensor system of claim 1, further comprising an electrical load element within said high temperature portion.

4. The sensor system of claim 3, wherein said measurement unit is arranged in close vicinity of or directly at said electrical load element.

5. The sensor system of claim 3, wherein said electrical load element comprises an actuator.

6. The sensor system of claim 5, wherein said actuator comprises a power actuator.

7. The sensor system of claim 3, wherein said electrical load element comprises a resistive heating element.

8. The sensor system of claim 3, wherein said electrical load element is electrically fed via a power line and wherein said power line is also connected to said measurement unit for data communication.

9. The sensor system of claim 8, wherein said power line is functionally connecting said measurement unit and a control unit for data communication, and wherein said control unit is in said low temperature portion.

10. The sensor system of claim 9, wherein said control unit receives sensor data via the measurement unit and controls a power supply to said electric load element.

11. The sensor system of claim 8, said data communication comprising a Power Line Communication.

12. The sensor system of claim 11, a carrier frequency for said Power Line Communication data communication between about 1 MHz and 999 MHz.

13. The sensor system of claim 12, wherein said carrier frequency equals a clock frequency of a logic circuitry.

14. The sensor system of claim 11, wherein said Power Line Communication employs an Amplitude Shift Keying modulation.

15. The sensor system of claim 14, wherein said Amplitude Shift Keying modulation comprises an On/Off Keying modulation.

16. The sensor system of claim 11, wherein a maximum peak-to-peak Amplitude Shift Keying modulation amplitude ranges from about IV to about 5V.

17. The sensor system of claim 8, wherein a frequency of a power current is in the range of about 1 KHz to about 999 KHz.

18. The sensor system of claim 1, wherein said measurement unit comprises a data transmitter.

19. The sensor system of claim 18, wherein said data transmitter includes an outgoing data modulator.

20. The sensor system of claim 19, wherein said modulator comprises a single logic NAND gate.

21. The sensor system of claim 19, wherein the measurement unit further comprises a data receiver including an incoming data demodulator.

22. The sensor system of claim 21, further comprising a band pass filter connected in series with one of said modulator and demodulator.

23. The sensor system of claim 21, wherein said transmitter and said receiver are part of a transceiver unit.

24. The sensor system of claim 23, wherein said transceiver operates in a half duplex mode.

25. The sensor system of claim 23, wherein said transceiver is integrated on a single chip.

26. The sensor system of claim 23, wherein said transceiver is connected to a logic circuitry connecting said transceiver circuit to said sensor.

27. The sensor system of claim 1, wherein said measurement unit comprises an analog interface for connection with said sensor.

28. The sensor system of claim 27, wherein said analog interface comprises a multiplexer with an input port and several output ports for consecutively switching a measuring current from said input port to said several output ports, and wherein one of said output ports of said analog interface is connected to a resistive sensor element.

29. The sensor system of claim 28, wherein several of said output ports of said analog interface are each connected to a respective resistive sensor element.

30. The sensor system of claim 28, wherein said resistive sensor element comprises a Resistance Temperature Detector.

31. The sensor system of claim 28, wherein two of said output ports of said analog interface are each connected to a respective reference resistor.

32. The sensor system of to claim 31, wherein said sensor system employs a ratiometric measurement technique to measure a sensor value.

33. The sensor system of claim 28, wherein said multiplexer sweeps between about five and about twenty times a second.

34. The sensor system of claim 28, wherein said analog interface is coupled to a logic circuitry of said transceiver circuit via an analog-to-digital converter.

35. The sensor system of claim 1, said measurement unit is integrated on a single chip.

36. The sensor system of claim 1, further comprising a data transmitter connecting said measurement unit and a control unit within said low temperature portion.

37. The sensor system of claim 9, further comprising a contactless connector with inductive coupling, wherein a low temperature side of the contactless connector is connected to said control unit via a first section of said power line and wherein a high temperature side of said contactless connector is connected to said electrical load element and said measurement electronics via a second section of said power line.

38. The sensor system of claim 37, wherein the low temperature side of the contactless connector comprises part of a household appliance.

39. The sensor system of claim 38, wherein the high temperature side of the contactless connector comprises part of a cookware.

40. The sensor system according to claim 38, wherein the high temperature side of the contactless connector comprises part of a coffee maker.

41. A household appliance system including a sensor system, said sensor system comprising:
a low temperature portion adapted for use in a low temperature environment;
a high temperature portion adapted for use in a high temperature environment;
a sensor arranged within said high temperature portion; and
a measurement unit in said high temperature portion and functionally connected to said sensor to read out respective sensor signals.

42. The household appliance of claim 41, further comprising an electrical load element within said high temperature portion, wherein said electrical load element is electrically fed via a power line, and wherein said power line is connected to said measurement unit for data communication.

43. The household appliance of claim 42, wherein said power line connects said measurement unit and a control unit for data communication, wherein said control unit is in said low temperature portion, and wherein said control unit receives sensor data from the measurement unit and controls a power supply to said electric load element.

43. A household appliance comprising
an electrical load element;
a sensor;
a measurement unit functionally connected to said sensor to read out respective sensor signals, wherein said electrical load element, said sensor, and said measurement unit are adapted for use within a high temperature environment, wherein said electrical load element is electrically fed via a power line that connects to said measurement unit for data communication; and
one side of a contactless connector with inductive coupling, that is connected to said electrical load element and said measurement unit via said power line.

44. A method for operating a sensor system, said method comprising:
providing a sensor system that includes a low temperature portion adapted for use in a low temperature environment, a high temperature portion adapted for use in a high temperature environment, a sensor arranged within said high temperature portion, a measurement unit in said high temperature portion and functionally connected to said sensor to read out respective sensor signals; and
measuring a sensor value with said measurement unit using a ratiometric measuring technique.

45. A method for sensing a sensor value, said method comprising:
measuring a sensor signal from a sensor in a high temperature environment;
transforming said sensor signal into a sensor value with measurement electronics in said high temperature environment; and
transmitting said sensor value to a control unit in a low temperature environment by means of a Power Line Communication technique.
